(19) United States
(12) Patent Application Publication
(10) Pub. No.: US 2020/0325715 A1
(43) Pub. Date: Oct. 15, 2020

(54) MOUNTING ASSEMBLY WITH GRAVITY HINGE AND REALIGNMENT ASSISTANCE FEATURE

(71) Applicant: PDT Systems, LLC, Buford, GA (US)

(72) Inventors: Robert William Sengstaken, JR., Hollis, NH (US); Robert Kendall Ufford, Acworth, GA (US)

(21) Appl. No.: 16/848,388

(22) Filed: Apr. 14, 2020

Related U.S. Application Data
(60) Provisional application No. 62/834,006, filed on Apr. 15, 2019.

(51) Int. Cl. E05F 1/06; E05F 15/614

(52) U.S. Cl. CPC E05F 1/063; H01Q 1/2208; E05F 15/614

(57) ABSTRACT

A mounting assembly is disclosed. The mounting assembly may include a surface mounting portion and a load mounting portion connected by an intervening gravity hinge portion. The gravity hinge portion may be configured, in accordance with some embodiments, to permit the load mounting portion to be deflected away from a nominal azimuth position and to return to that position under the action of gravity. In this manner, the mounting assembly may be configured to maintain a desired alignment of a given load hosted thereby, as well as absorb impact thereto. In accordance with some embodiments, the gravity hinge portion also may include one or more realignment assistance features configured to assist with returning to the nominal azimuth position.

### CROSS-REFERENCE TO RELATED APPLICATIONS

This patent application claims the benefit of U.S. Provisional Patent Application No. 62/834,006, titled “Swing-Arm Antenna Mount,” filed on Apr. 15, 2019, which is herein incorporated by reference in its entirety.

### FIELD OF THE DISCLOSURE

The present disclosure relates to mounting hardware and, more particularly, to a mounting assembly including a gravity hinge and realignment assist feature.

### BACKGROUND

As a mechanical bearing, a hinge connects two bodies in a manner that permits only a limited range of rotation between them. The two bodies linked by the hinge may rotate relative to one another about an axis of rotation defined by the hinge. Typically, hinges permit only one degree of freedom of movement.

### SUMMARY

The subject matter of this application may involve, in some cases, interrelated products, alternative solutions to a particular problem, and/or a plurality of different uses of a single system or article.

One example embodiment provides a mounting assembly. The mounting assembly includes a surface mounting portion configured to be mounted to a mounting surface. The mounting assembly further includes a load mounting portion configured to have a load mounted thereto. The mounting assembly further includes a swing-arm with a centering mechanism connected with the surface mounting portion and the load mounting portion and configured to permit the load mounting portion to be deflected away from a nominal azimuth position and to return to that nominal azimuth position automatically. In some cases, the swing-arm with the centering mechanism includes a gravity hinge portion including: a lower gravity hinge part; an upper gravity hinge part; a hinge pin pivotally connecting the lower gravity hinge part and the upper gravity hinge part such that the upper gravity hinge part automatically realigns with the lower gravity hinge part from a deflected position to a nominal azimuth position under the action of gravity; and at least one realignment assistance feature configured to assist with the automatic realignment of the upper gravity hinge part with the lower gravity hinge part. In some such instances, the gravity hinge portion further includes: a first arm connected to the lower gravity hinge part and the surface mounting portion; and a second arm connected to the upper gravity hinge part and the load mounting portion. In some such instances, the load mounting portion is pivotally connected to the second arm. In some cases, the at least one realignment assistance feature includes: a spring situated with the hinge pin inserted therein, wherein the spring is configured to be compressed when the upper gravity hinge part is in the deflected position; and a locking pin retaining the spring in position on the hinge pin. In some cases, the at least one realignment assistance feature includes: a first magnet hosted by the lower gravity hinge part; and a second magnet hosted by the upper gravity hinge part; wherein the first magnet and the second magnet are oriented such that there is magnetic attraction therebetween. In some such instances, the first magnet is hosted in a recess provided in the lower gravity hinge part. In some other such instances, the second magnet is hosted in a recess provided in the upper gravity hinge part. In some cases, the at least one realignment assistance feature includes: a magnet hosted by one of either the lower gravity hinge part or the upper gravity hinge part; and a magnetic plate hosted by the other of either the lower gravity hinge part or the upper gravity hinge part; wherein the magnet and the magnetic plate are oriented such that there is magnetic attraction therebetween. In some such instances, the magnet is hosted in a recess provided in either the lower gravity hinge part or the upper gravity hinge part. In some other such instances, the magnetic plate is hosted in a recess provided in either the lower gravity hinge part or the upper gravity hinge part. In some cases, the at least one realignment assistance feature includes: a first realignment assistance feature including: a spring situated with the hinge pin inserted therein, wherein the spring is configured to be compressed when the upper gravity hinge part is in the deflected position; and a locking pin retaining the spring in position on the hinge pin; and a second realignment assistance feature including: a first magnet hosted by the lower gravity hinge part; and a second magnet hosted by the upper gravity hinge part; wherein the first magnet and the second magnet are oriented such that opposite magnetic poles thereof are directed toward one another, permitting magnetic attraction therebetween. In some cases, the at least one realignment assistance feature includes: a first realignment assistance feature including: a spring situated with the hinge pin inserted therein, wherein the spring is configured to be compressed when the upper gravity hinge part is in the deflected position; and a locking pin retaining the spring in position on the hinge pin; and a second realignment assistance feature including: a magnet hosted by one of either the lower gravity hinge part or the upper gravity hinge part; and a magnetic plate hosted by the other of either the lower gravity hinge part or the upper gravity hinge part; wherein the magnet is oriented such that one of its magnetic poles is directed toward the magnetic plate, permitting magnetic attraction therebetween. In some cases, the swing-arm with the centering mechanism includes an azimuth adjustment feature. In some such instances, the swing-arm with the centering mechanism further includes an elevation adjustment feature. In some cases, a system is provided, the system including: the mounting assembly; and the load, wherein the load includes at least one of an antenna, a radio frequency identification (RFID) antenna, surveillance equipment, a camera, a video recorder, a scanner, a display, a monitor, a television, a sensor, and an infrared (IR) sensor.

Another example embodiment provides a mounting assembly. The mounting assembly includes a surface mounting portion configured to be fixed to a mounting surface. The mounting assembly further includes a first arm connected to the surface mounting portion. The mounting assembly further includes a first gravity hinge part connected to the first arm. The mounting assembly further includes a second gravity hinge part pivotally connected to the first gravity hinge part by a hinge pin such that the second gravity hinge part automatically realigns with the first gravity hinge part from a deflected position to a nominal azimuth position under the action of gravity. The mounting assembly further includes a second arm connected to the second gravity hinge part. The mounting assembly further includes a load mounting portion connected to the second arm and configured to host a load. The mounting assembly further includes at least one realignment assistance feature configured to assist with the automatic realignment of the second gravity hinge part with the first gravity hinge part. In some cases, the at least one realignment assistance feature includes at least one magnet. In some such instances, the at least one realignment assistance feature further includes a magnetic plate disposed within a magnetic field of the at least one magnet. In some cases, the at least one realignment assistance feature includes at least two magnets oriented with opposing magnetic poles directed toward one another. In some cases, the first arm is configured to be adjusted in its connection with the surface mounting portion so as to set the nominal azimuth position. In some cases, the second arm is configured to be adjusted in its connection with the load mounting portion so as to set an elevation angle of the load mounting portion. In some cases, a system is provided, the system including: the mounting assembly; and the load, wherein the load includes at least one of an antenna, a radio frequency identification (RFID) antenna, surveillance equipment, a camera, a video recorder, a scanner, a display, a monitor, a television, a sensor, and an infrared (IR) sensor.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is an isometric view of a mounting assembly configured in accordance with an embodiment of the present disclosure.

FIG. 2 is a side elevation view of the mounting assembly of FIG. 1.

FIG. 3 is an exploded side elevation view of the mounting assembly of FIG. 1.

FIG. 4 is an isometric view of a surface mounting portion configured in accordance with an embodiment of the present disclosure.

FIG. 5 is another isometric view of the surface mounting portion of FIG. 4.

FIG. 6 is an isometric view of a gravity hinge portion configured in accordance with an embodiment of the present disclosure.

FIG. 7 is an exploded side elevation view of the gravity hinge portion of FIG. 6.

FIG. 8 is an isometric view of a first arm configured in accordance with an embodiment of the present disclosure.

FIG. 9 is an isometric view of a lower hinge part configured in accordance with an embodiment of the present disclosure.

FIG. 10 is a side elevation view of the lower hinge part of FIG. 9.

FIG. 11 is an isometric view of a second arm configured in accordance with an embodiment of the present disclosure.

FIG. 12 is an isometric view of an upper hinge part configured in accordance with an embodiment of the present disclosure.

FIG. 13 is a side elevation view of the upper hinge part of FIG. 12.

FIG. 14A is an isometric partial view of a gravity hinge portion in a nominal azimuth position, in accordance with an embodiment of the present disclosure.

FIG. 14B is a side elevation view of the gravity hinge portion in the nominal azimuth position shown in FIG. 14A.

FIG. 15A is an isometric partial view of the gravity hinge portion of FIGS. 14A-14B in a deflected position, in accordance with an embodiment of the present disclosure.

FIG. 15B is a side elevation view of the gravity hinge portion in the deflected position shown in FIG. 15A.

FIG. 16 is an exploded isometric partial view of a gravity hinge portion including two magnets, in accordance with an embodiment of the present disclosure.

FIG. 17 is an exploded isometric partial view of a gravity hinge portion including a magnet and a magnetic plate, in accordance with an embodiment of the present disclosure.

FIG. 18 is an isometric view of a load mounting portion configured in accordance with an embodiment of the present disclosure.

FIG. 19 is another isometric view of the load mounting portion of FIG. 18.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

A mounting assembly is disclosed. The mounting assembly may include a surface mounting portion and a load mounting portion connected by an intervening gravity hinge portion. The gravity hinge portion may be configured, in accordance with some embodiments, to permit the load mounting portion to be deflected away from a nominal azimuth position and to return to that position under the action of gravity. In this manner, the mounting assembly may be configured to maintain a desired alignment of a given load hosted thereby, as well as absorb impact thereto. In accordance with some embodiments, the gravity hinge portion also may include one or more realignment assistance features configured to assist with returning to the nominal azimuth position. Numerous configurations and variations will be apparent in light of this disclosure.

General Overview

Antennas used for reading passive radio frequency identification (RFID) tags generally need to be aimed to read tagged items as they pass by within the transmitted RF field. Often, such RFID antennas need to be within 10-15 ft of the RFID-tagged object to ensure proper scanning. However, RFID antennas can be somewhat prominent in profile, being about 5-10 in² and 1-2 in thick, and oftentimes must be installed in locations (e.g., loading docks) where they are at risk of damage by impact from vehicles (e.g., trucks, forklifts) and other moving objects. Thus, with existing fixed antenna mount designs, the RFID antenna can become misaligned or even broken when so impacted. Misalignment may cause the RFID antenna to no longer provide a sufficiently focused RF field to read RFID tags passing by. Damage to RFID antenna enclosures can permit water, dust, and other environmental hazards to enter, causing device failure.

Thus, and in accordance with some embodiments of the present disclosure, a mounting assembly is disclosed. The mounting assembly may include a surface mounting portion and a load mounting portion connected by an intervening gravity hinge portion. The gravity hinge portion may be configured, in accordance with some embodiments, to permit the load mounting portion to be deflected away from a nominal azimuth position and to return to that position under the action of gravity. In this manner, the mounting assembly may be configured to maintain a desired alignment of a given load hosted thereby, as well as absorb impact thereto. In accordance with some embodiments, the gravity hinge portion also may include one or more realignment assistance features configured to assist with returning to the nominal azimuth position.

In accordance with some embodiments, the disclosed mounting assembly may be configured to automatically return a hosted load to a given nominal azimuth position after receiving a deflecting impact. To that end, the gravity hinge portion (and any realignment assistance feature, if present) of the mounting assembly may facilitate the return from deflection. The disclosed mounting assembly may be configured, in accordance with some embodiments, for quick and easy setting and adjustment of the nominal azimuth position and elevation/tilt angle for a given load at a given installation site. In accordance with some embodiments, the disclosed mounting assembly generally may be considered as including a swing-arm with a centering mechanism configured to permit an attached load to be deflected away from a nominal azimuth position and to return to that nominal azimuth position automatically. In some instances, the swing-arm with the centering mechanism may include, for example, an azimuth adjustment feature and/or an elevation adjustment feature. In some embodiments, a mounting assembly provided as described herein may be configured, for example, as: (1) a partially/completely assembled unit; and/or (2) a kit or other collection of discrete components (e.g., surface mounting portion, gravity hinge portion, load mounting portion, etc.) which may be operatively coupled as desired.

Numerous suitable uses and applications of the disclosed mounting assembly will be apparent in light of this disclosure. For instance, in accordance with some embodiments, a mounting assembly provided as described herein may be mounted on a shipping dock or doorway and may host an RF antenna positioned to provide a focused RF field on an area where a conveyor belt is transferring packages into a truck.

Structure and Operation

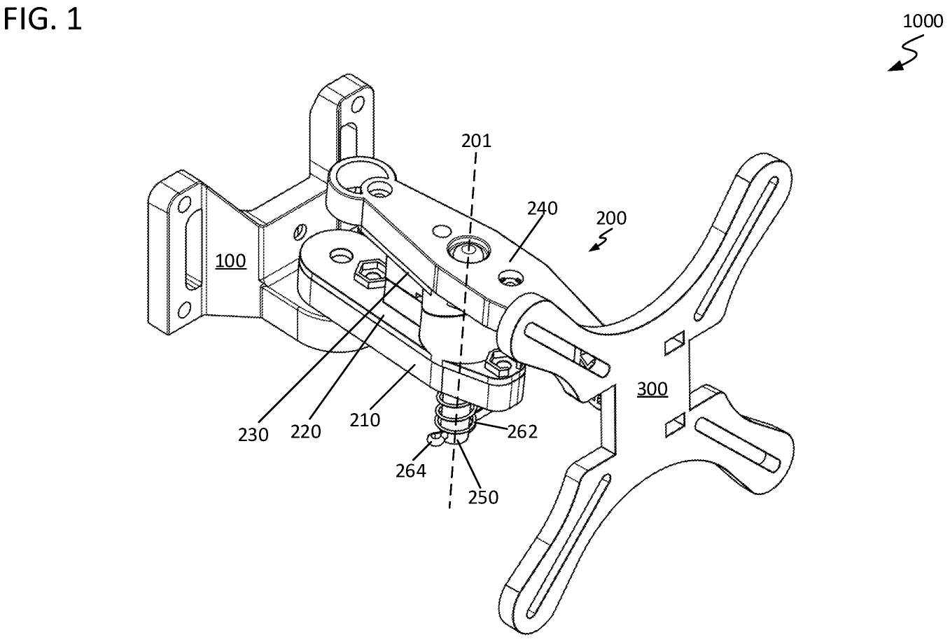

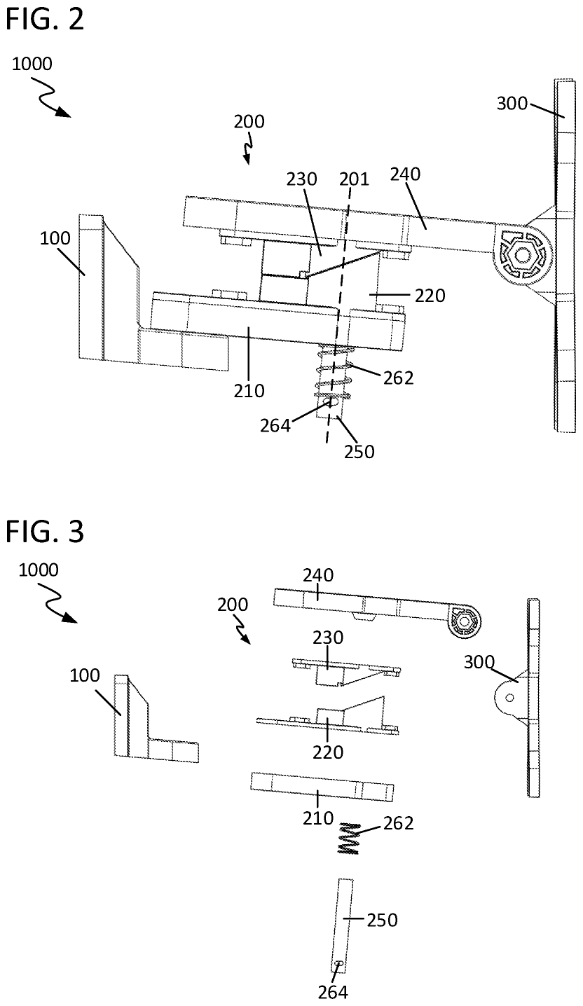

FIGS. 1-3 illustrate several views of a mounting assembly 1000 configured in accordance with an embodiment of the present disclosure. As can be seen, assembly 1000 may include (1) a surface mounting portion 100 at a first end of assembly 1000, (2) a load mounting portion 300 at a second end of assembly 1000, and (3) a gravity hinge portion 200 connected with surface mounting portion 100 and load mounting portion 300. Each of these various elements is discussed in turn below.

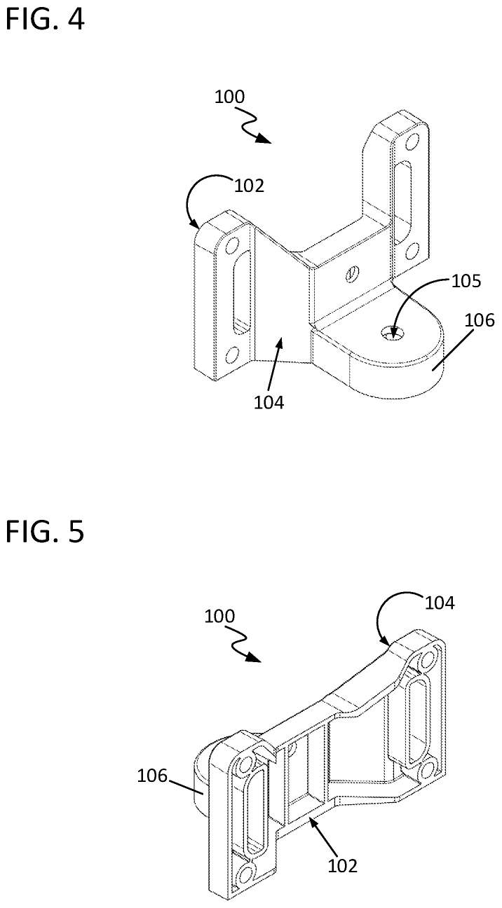

As noted above, assembly 1000 may include a surface mounting portion 100. FIGS. 4-5 illustrate several views of a surface mounting portion 100 configured in accordance with an embodiment of the present disclosure. As can be seen, surface mounting portion 100 may be generally configured as a bracket, the dimensions and geometry of which may be customized, as desired for a given target application or end-use. Surface mounting portion 100 may be configured to be mounted to a given mounting surface, affixing assembly 1000 thereto in a temporary or permanent manner. To that end, rearward side 102 (and/or other portion) of surface mounting portion 100 may be configured to interface, directly or indirectly, with a given mounting surface, as desired. Some example suitable mounting surfaces may include, for instance, a wall, a ceiling, a floor, a doorway, a post, a pole, a loading dock, a cart, a vehicle, or a container, among others. In some instances, surface mounting portion 100 may have a U-shaped cutout region to facilitate mounting, for example, to a pole. In some cases, surface mounting portion 100 may interface with a given mounting surface in a manner that provides for a given degree of pivoting or flexing, though in other cases, a rigid or immovable interfacing with the mounting surface may be provided. In a more general sense, surface mounting portion 100 may be configured to be attached to a given mounting surface in a manner that prevents (or otherwise reduces) the opportunity for unwanted movement of surface mounting portion 100 in relation to that mounting surface. Surface mounting portion 100 may be configured to receive (or otherwise utilize) one or more securing means, such as bolts, screws, clamps, or ties, to name a few options.

Surface mounting portion 100 may include an extension 106 having an aperture 105 formed therein. Extension 106 may be configured to have first arm 210 (discussed below) connected thereto. Extension 106 and its aperture 105 may be configured to provide for adjustment of the nominal azimuth position of assembly 1000. In some instances, extension 106 may be configured such that first arm 210 and any attendant downstream elements may be quickly disconnected from surface mounting portion 100.

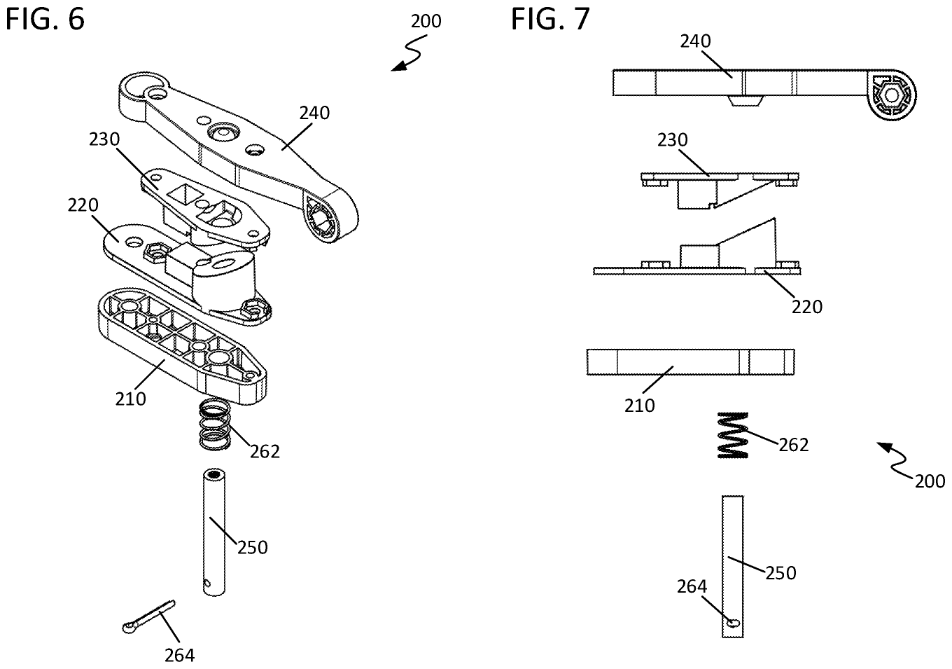

As noted above, assembly 1000 further may include a gravity hinge portion 200. FIGS. 6-7 illustrate several views of a gravity hinge portion 200 configured in accordance with an embodiment of the present disclosure. As can be seen, gravity hinge portion 200 may include (1) a first arm 210, (2) a lower hinge part 220 connected to first arm 210, (3) a second arm 240, (4) an upper hinge part 230 connected to second arm 240, and (5) a hinge pin 250 connecting lower hinge part 220 and upper hinge part 230 together along a hinge axis 201. Each of these various elements is discussed in turn below.

In general, gravity hinge portion 200 may be configured to provide assembly 1000 with a hinge joint about which arms 210, 240 (via their respective hinge parts 220, 230) automatically realign under the action of gravity. Thus, in this manner, gravity hinge portion 200 may be configured to automatically return load mounting portion 300 (via its connection to second arm 240 and, thus, upper hinge part 230) from a deflected position to a designated nominal azimuth position (e.g., a centered position, neutral position, or other target position) under the application of gravity. As will be appreciated in light of this disclosure, the realignment force of gravity hinge portion 200 may depend on any of a range of factors, including, for example, the weight of downstream element(s) (e.g., second arm 240, load mounting portion 300, and a given load), friction at the gravity hinge point between hinge part 220, 230 (discussed below), and the angle of the sloped surfaces 226, 236 (discussed below) of hinge parts 220, 230.

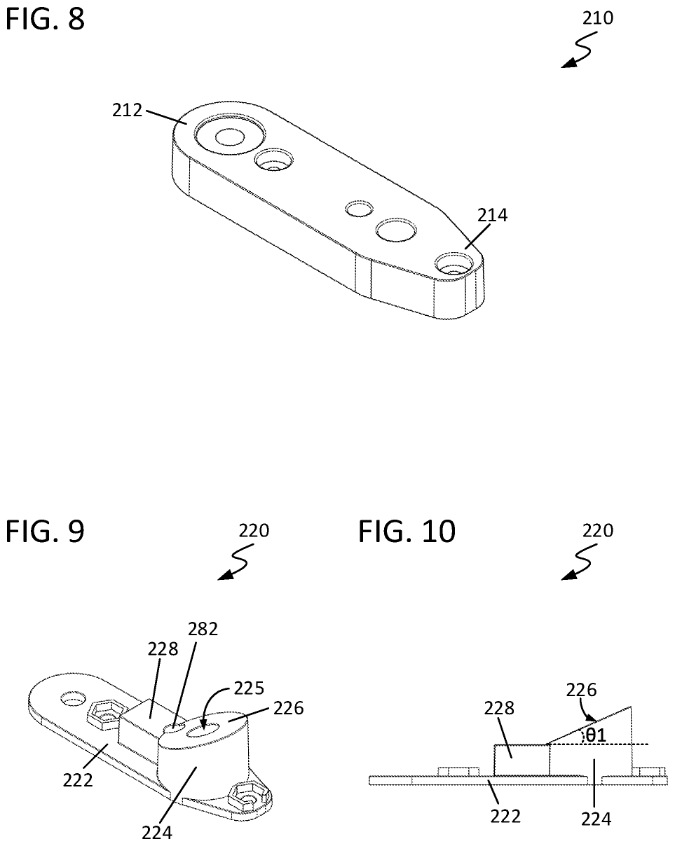

As noted above, gravity hinge portion 200 may include a first arm 210. FIG. 8 illustrates a first arm 210 configured in accordance with an embodiment of the present disclosure. As can be seen, first arm 210 may be generally configured as an elongate bar, the dimensions and geometry of which may be customized, as desired for a given target application or end-use. In some cases, first arm 210 may be constructed as a non-extensible element having a fixed overall length. In some other cases, however, first arm 210 may be capable of extending and/or collapsing to adjust its overall length (e.g., such as by telescoping, slide extension, etc.). In some instances, a distal end 214 of first arm 210 may be tapered, angled, or beveled to a given degree.

First arm 210 may be configured to interface, directly or indirectly, with (1) surface mounting portion 100 and (2) lower hinge part 220. For instance, a proximal end 212 of first arm 210 may be configured to be fixed or otherwise connected to extension 106 at a forward side 104 (and/or other portion) of surface mounting portion 100. In this manner, first arm 210 may be configured to connect gravity hinge portion 200 (and, thus, downstream load mounting portion 300) to surface mounting portion 100. To such ends, first arm 210 may be fastened (or otherwise connected) to surface mounting portion 100 and/or lower hinge part 220 using any suitable fastening (or other connection) means, as will be apparent in light of this disclosure. In some cases, first arm 210 may interface with surface mounting portion 100 and/or lower hinge part 220 in a manner that provides for a given degree of pivoting or flexing, though in other cases, a rigid or immovable interfacing with surface mounting portion 100 and/or lower hinge part 220 may be provided. In a more general sense, first arm 210 may be configured to be attached to surface mounting portion 100 and/or lower hinge part 220 in a manner that prevents (or otherwise reduces) the opportunity for unwanted movement of first arm 210 in relation to surface mounting portion 100 and/or lower hinge part 220. In accordance with some embodiments, proximal end 212 may connect with surface mounting portion 100 in a manner that permits adjustment and/or fixing of the nominal azimuth position of assembly 1000. For example, in some cases, first arm 210 may be angled by about 10-20° by surface mounting portion 100.

As noted above, gravity hinge portion 200 also may include a lower hinge part 220. FIGS. 9-10 illustrate several views of a lower hinge part 220 configured in accordance with an embodiment of the present disclosure. As can be seen, lower hinge part 220 may be configured to interface, directly or indirectly, with first arm 210 (e.g., at or near a distal end 214 thereof). To such ends, lower hinge part 220 may be fastened or otherwise connected to first arm 210 using any suitable fastening or other connection means, as will be apparent in light of this disclosure.

Lower hinge part 220 may include a base 222 having a knuckle 224 extending therefrom. Knuckle 224 may have formed therein a through-hole 225 configured to receive hinge pin 250. Through-hole 225 may be generally circular in cross-sectional profile. Knuckle 224 may be generally tubular or cylindrical in shape, having an annular (e.g., ring-like) or, more generally, circular cross-sectional profile. Knuckle 224 also may have a sloped surface 226 configured to interface, directly or indirectly, with a corresponding sloped surface 236 of upper hinge part 230 (discussed below). Sloped surface 226 may extend at an oblique angle (θ1), which may be customized, as desired for a given target application or end-use. In general, oblique angle (θ1) may be selected to complement oblique angle (θ2) (discussed below) for a given desired operation of gravity hinge portion 200.

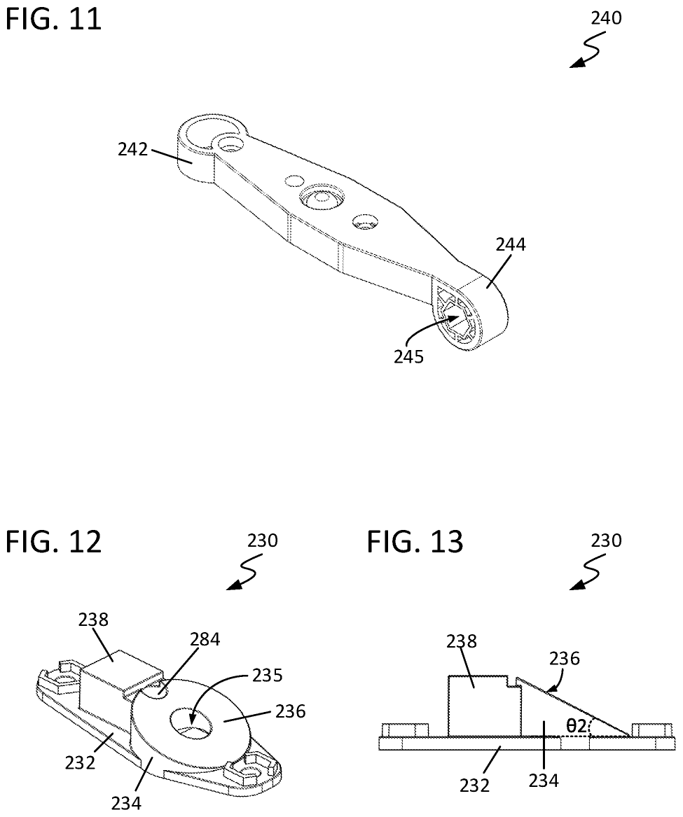

Also, as noted above, gravity hinge portion 200 may include a second arm 240. FIG. 11 illustrates a second arm 240 configured in accordance with an embodiment of the present disclosure. As can be seen, second arm 240 may be generally configured as an elongate bar, the dimensions and geometry of which may be customized, as desired for a given target application or end-use. In some cases, second arm 240 may be constructed as a non-extensible element having a fixed overall length. In some other cases, however, second arm 240 may be capable of extending and/or collapsing to adjust its overall length (e.g., such as by telescoping, slide extension, etc.).

Second arm 240 may be configured to interface, directly or indirectly, with (1) load mounting portion 300 and (2) upper hinge part 230. For instance, a distal end 244 of second arm 240 may be configured to have an extension 306 at rearward side 302 (and/or other portion) of load mounting portion 300 fixed or otherwise connected thereto. In this manner, second arm 240 may be configured to connect downstream load mounting portion 300 to gravity hinge portion 200 (and, thus, upstream surface mounting portion 100). To such ends, second arm 240 may be fastened (or otherwise connected) to load mounting portion 300 and/or upper hinge part 230 using any suitable fastening (or other connection) means, as will be apparent in light of this disclosure. In some cases, second arm 240 may interface with load mounting portion 300 and/or upper hinge part 230 in a manner that provides for a given degree of pivoting or flexing, though in other cases, a rigid or immovable interfacing with load mounting portion 300 and/or upper hinge part 230 may be provided. In a more general sense, second arm 240 may be configured to be attached to load mounting portion 300 and/or upper hinge part 230 in a manner that prevents (or otherwise reduces) the opportunity for unwanted movement of second arm 240 in relation to load mounting portion 300 and/or upper hinge part 230.

As can be seen further, a distal end 244 of second arm 240 may include a pivot point 245. Pivot point 245 may be configured to pivotally connect load mounting portion 300 with second arm 240, allowing for angular adjustment of load mounting portion 300 in one or more directions (e.g., elevation angle/tilt adjustment). In some cases, a locking bolt or other suitable fastening or connection element (e.g., a pin, rod, etc.) may be interfaced with pivot point 245 to pivotally connect load mounting portion 300 therewith. In some other cases, a ball-and-socket arrangement may be provided at pivot point 245 to pivotally connect load mounting portion 300 therewith.

As noted above, gravity hinge portion 200 further may include an upper hinge part 230. FIGS. 12-13 illustrate several views of an upper hinge part 230 configured in accordance with an embodiment of the present disclosure. As can be seen, upper hinge part 230 may be configured to interface, directly or indirectly, with second arm 240 (e.g., at or near a proximal end 242 thereof). To such ends, upper hinge part 230 may be fastened or otherwise connected to second arm 240 using any suitable fastening or other connection means, as will be apparent in light of this disclosure.

Upper hinge part 230 may include a base 232 having a knuckle 234 extending therefrom. Knuckle 234 may have formed therein a through-hole 235 configured to receive hinge pin 250. Through-hole 235 may be generally circular in cross-sectional profile. Knuckle 234 may be generally tubular or cylindrical in shape, having an annular (e.g., ring-like) or, more generally, circular cross-sectional profile. Knuckle 234 also may have a sloped surface 236 configured to interface, directly or indirectly, with a corresponding sloped surface 226 of lower hinge part 220. Sloped surface 226 may extend at an oblique angle (θ2), which may be customized, as desired for a given target application or end-use. In general, oblique angle (θ2) may be selected to complement oblique angle (θ1) for a given desired operation of gravity hinge portion 200.

Additionally, as noted above, gravity hinge portion 200 may include a hinge pin 250. As can be seen from FIGS. 3 and 6, for example, hinge pin 250 may be a generally elongate pin (e.g., spindle, shaft, rod), the dimensions and geometry of which may be customized, as desired for a given target application or end-use. As shown, hinge pin 250 may be generally cylindrical in shape, having a generally circular cross-sectional profile.

Hinge pin 250 may be configured to interface, directly or indirectly, with (1) knuckle 234 of upper hinge part 230 and (2) knuckle 224 of lower hinge part 220. That is, hinge pin 250 may be configured to be set through knuckles 224, 234, being received by both lower hinge part 220 and upper hinge part 230 in the region of sloped surfaces 226, 236. In this manner, hinge pin 250 may be configured to connect lower hinge part 220 and upper hinge part 230 to establish rotating communication therebetween. Hinge pin 250 generally may be configured to extend downwardly from second arm 240, through first arm 210, beyond the extent of first arm 210. In some cases, hinge pin 250 may be formed integrally (e.g., formed as a single, monolithic piece) with second arm 240. In other cases, hinge pin 250 may be a body separate and distinct from second arm 240 and configured to connect with second arm 240 (e.g., via a threaded interface, fastener, adhesive, friction fit, etc.).

In assembly of gravity hinge portion 200, lower hinge part 220 and upper hinge part 230 may be situated such that sloped surfaces 226, 236 are opposed to one another. Oblique angles (θ1) and (θ2) may be complementary to one another and, at least in some instances, may be approximately equivalent. In some cases, knuckles 224, 234 may be arranged such that sloped surfaces 226, 236 are in direct contact with one another. In some other cases, a small gap between knuckles 224, 234 may be provided, optionally having a bushing (e.g., a spacer, friction-reducing element, etc.) disposed therein between sloped surfaces 226, 236.

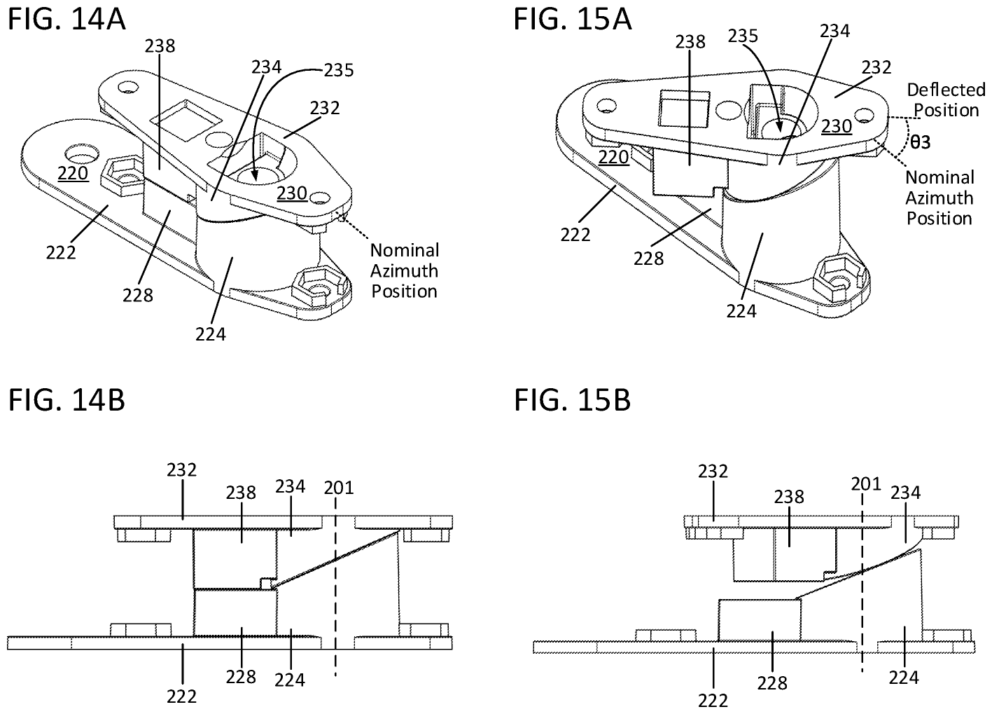

As noted above, gravity hinge portion 200 may be configured to provide assembly 1000 with the ability to undergo deflection from some nominal azimuth position about hinge axis 201 and automatically return to that nominal azimuth position when deflection ceases. FIGS. 14A-14B illustrate several views of upper hinge part 230 in a given nominal azimuth position over lower hinge part 220 in accordance with an embodiment of the present disclosure. FIGS. 15A-15B illustrate several views of upper hinge part 230 in a deflected position over lower hinge part 220 in accordance with an embodiment of the present disclosure. As can be seen, upper hinge part 230 may be configured to rotate about an oblique junction between its knuckle 236 and corresponding knuckle 226 of lower hinge part 220 upon application of sufficient deflecting force (e.g., sufficient torque) to any downstream element (e.g., second arm 240, load mounting portion 300, or a load hosted by load mounting portion 300). As upper hinge part 230 rotates, knuckles 226, 236 at least partially separate due to the oblique junction therebetween, and upper hinge part 230 is displaced vertically (e.g., rises along a helical axis). When application of the deflecting force ceases, upper hinge part 230 descends (e.g., falls along a helical axis), rotating back to its original nominal azimuth position (e.g., a centered position, neutral position, or other designated position), terminating deflection.

In some embodiments, gravity hinge portion 200 may be configured as a single-action hinge assembly able to swing from the nominal azimuth position in only one direction (e.g., clockwise or counterclockwise relative to hinge axis 201). In some other embodiments, however, gravity hinge portion 200 may be configured as a double-action hinge assembly able to swing from the nominal azimuth position in two directions (e.g., clockwise and counterclockwise relative to hinge axis 201.)

In accordance with some embodiments, a nominal azimuth position for assembly 1000 may be set by rotating gravity hinge portion 200 horizontally and locking it in place (e.g., by a suitable fastener). Moreover, the permissible range of deflection angle (θ3) may be customized, as desired for a given target application or end-use. In some cases, deflection angle (θ3) may be in the range of about 90° or less (e.g., about 30° or less, about 45° or less, about 60° or less, or any other sub-range in the range of about 90° or less). In some cases, deflection angle (θ3) may be in the range of about 180° or less (e.g., about 135° or less, about 150° or less, about 175° or less, or any other sub-range in the range of about 180° or less). In some cases, deflection angle (θ3) may be in the range of about 180° or more (e.g., about 210° or more, about 240° or more, about 270° or more, or any other sub-range in the range of about 180° or more).

Furthermore, as noted above, gravity hinge portion 200 optionally may include one or more realignment assistance features generally configured to assist with returning gravity hinge portion 200 from a deflected position to a nominal azimuth position. For instance, as can be seen from FIGS. 1-3, gravity hinge portion 200 may include, as a realignment assistance feature, a spring 262 and locking pin 264, in accordance with some embodiments. Spring 262 may be configured to be positioned on hinge pin 250 so as to be compressed to a given degree as upper hinge part 230 rises and hinge pin 250 correspondingly ascends through knuckle 224. To retain spring 262 in position along the length of hinge pin 250, a locking pin 264 may be interfaced with hinge pin 250 (e.g., at a through-hole, recess, or other suitable feature). Thus, once upper hinge part 230 is permitted to fall and hinge pin 250 correspondingly is able to descend through knuckle 224, the restorative force of compressed spring 262 may push against locking pin 264, assisting in the forced descent of hinge pin 250 and the return of upper hinge part 230 from a deflected position to a nominal azimuth position. The spring constant and, thus, restorative force of spring 262 may be customized, as desired for a given target application or end-use. In some embodiments, spring 262 may be configured to undergo compression in providing its restorative force, whereas in some other embodiments, spring 262 may be configured to undergo elongation in providing such force.

In accordance with some embodiments, gravity hinge portion 200 may include, as a realignment assistance feature, a pair of magnets 272, 274 respectively hosted by first arm 210 and second arm 240. FIG. 16 illustrates a partial view of a gravity hinge portion 200 including a pair of magnets 272, 274 configured in accordance with an embodiment of the present disclosure. As can be seen, a first magnet 272 may be hosted by lower hinge part 220 (e.g., at a recess 228 or other region thereof). A corresponding second magnet 274 may be hosted by upper hinge part 230 (e.g., at a recess 238 or other region thereof). Magnets 272, 274 may be oriented so that their opposite magnetic poles are directed toward one another, permitting magnetic attraction therebetween. When upper hinge part 230 is deflected, magnets 272, 274 are rotationally separated from one another. Thus, once upper hinge part 230 is permitted to fall and hinge pin 250 correspondingly is able to descend through knuckle 224, the magnetic attraction between magnets 272, 274 may pull upper hinge part 230 laterally/radially into alignment with lower hinge part 220, assisting in the return of upper hinge part 230 from a deflected position to a nominal azimuth position. When deflection ceases, magnets 272, 274 rotationally move closer to one another via their magnetic attraction and the action of gravity hinge portion 200.

In some embodiments, a given magnet 272, 274 may be a permanent magnet, such as a ferrite magnet or a rare-earth magnet, for example, though other suitable magnetic materials may be utilized. In some embodiments, a given magnet 272, 274 may be configured as an electromagnet operatively coupled with an appropriate current source hosted by or otherwise interfaced with assembly 1000. The shape (e.g., cube, bar, cylinder, disc, sphere, etc.), dimensions, and magnetic field strength of a given magnet 272, 274 may be customized, as desired for a given target application or end-use. Retention of a given magnet 272, 274 by a corresponding hinge part 220, 230 may be provided by an adhesive, a friction fit, or other suitable means, as will be apparent in light of this disclosure.

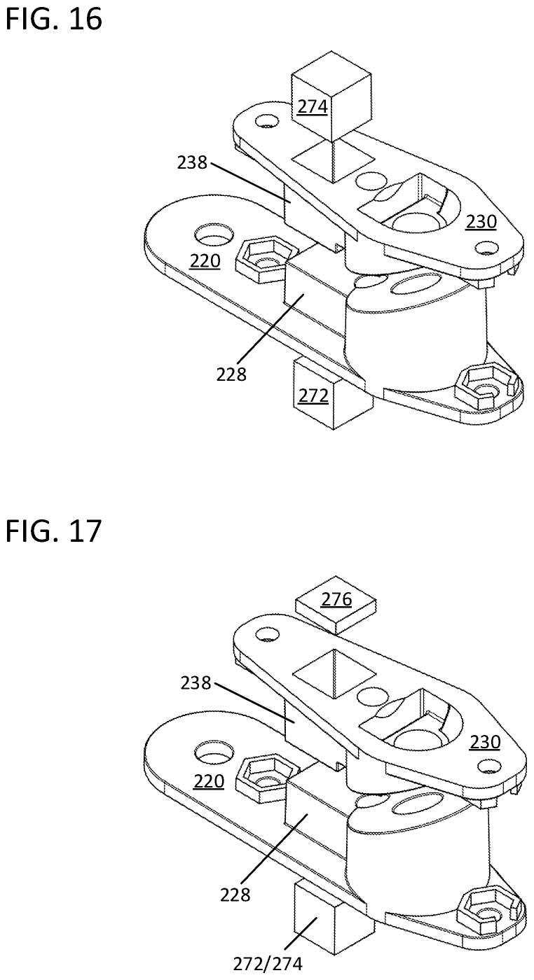

In accordance with some embodiments, gravity hinge portion 200 may include, as a realignment assistance feature, a magnet 272/274 and a corresponding magnetic plate 276. FIG. 17 illustrates a partial view of a gravity hinge portion 200 including a magnet 272/274 and a magnetic plate 276 configured in accordance with an embodiment of the present disclosure. As can be seen, magnet 272/274 may be hosted by one of either lower hinge part 220 (e.g., at a recess 228 or other region thereof) or upper hinge part 230 (e.g., at a recess 238 or other region thereof). A corresponding magnetic plate 276 may be hosted by the other of either lower hinge part 220 (e.g., at recess 228 or other region thereof) or upper hinge part 230 (e.g., at recess 238 or other region thereof). Magnet 272/274 may be oriented so that one of its magnetic poles is directed toward magnetic plate 276, permitting magnetic attraction therebetween. When upper hinge part 230 is deflected, magnet 272/274 and magnetic plate 276 are rotationally separated from one another. Thus, once upper hinge part 230 is permitted to fall and hinge pin 250 correspondingly is able to descend through knuckle 224, the magnetic attraction between magnet 272/274 and magnetic plate 276 may pull upper hinge part 230 laterally/radially into alignment with lower hinge part 220, assisting in the return of upper hinge part 230 from a deflected position to a nominal azimuth position. When deflection ceases, magnet 272/274 and magnetic plate 276 rotationally move closer to one another via their magnetic attraction and the action of gravity hinge portion 200.

In some embodiments, magnetic plate 276 may be made from ferromagnetic material(s), ferrimagnetic material(s), ferrous material(s), or any other material(s) having sufficiently high susceptibility to an applied magnetic field. In some embodiments, magnetic plate 276 may be configured as an electromagnet operatively coupled with an appropriate current source hosted by or otherwise interfaced with assembly 1000. The shape (e.g., cube, bar, cylinder, disc, sphere, etc.), dimensions, and magnetic field susceptibility of magnetic plate 276 may be customized, as desired for a given target application or end-use. Retention of magnet 272/274 and magnetic plate 276 by a corresponding hinge part 220, 230 may be provided by an adhesive, a friction fit, or other suitable means, as will be apparent in light of this disclosure.

In accordance with some embodiments, hinge portion 200 may include a combination of realignment assistance features. For instance, in some cases, (1) a spring 262 and locking pin 264 as well as (2) a pair of magnets 272, 274 may be utilized. In some other cases, (1) a spring 262 and locking pin 264 as well as (2) a magnet 272/274 and magnetic plate 276 may be utilized. Numerous configurations and variations for gravity hinge portion 200 (as well as assembly 1000 more generally) will be apparent in light of this disclosure.

In some embodiments, gravity hinge portion 200 optionally may include a deflection resistance feature configured to resist (but not prevent) deflection of upper hinge part 230 from a nominal azimuth position. For example, as can be seen in FIGS. 9 and 12, one of either lower hinge part 220 or upper hinge part 230 may include a protrusion 282 (e.g., a tab, bump, extension, etc.), and the other of either lower hinge part 220 or upper hinge part 230 may include a corresponding recess 284 (e.g., a notch, slot, channel, etc.). Protrusion 282 and recess 284 may interface (e.g., in at least partially mated engagement) in a manner resistant to disengagement in cases of application of a deflection force below threshold. Thus, protrusion 282 and recess 284 may be configured to provide a sort of detent feature that tends to maintain lower hinge part 220 and upper hinge part 230 in alignment with one another, holding downstream load mounting portion 300 in a given nominal azimuth position (e.g., a centered position, a neutral position). In some instances, magnetic attraction between two magnets 272, 274 or between magnet 272/274 and magnetic plate 276, if any are present, additionally or alternatively may tend to keep alignment.

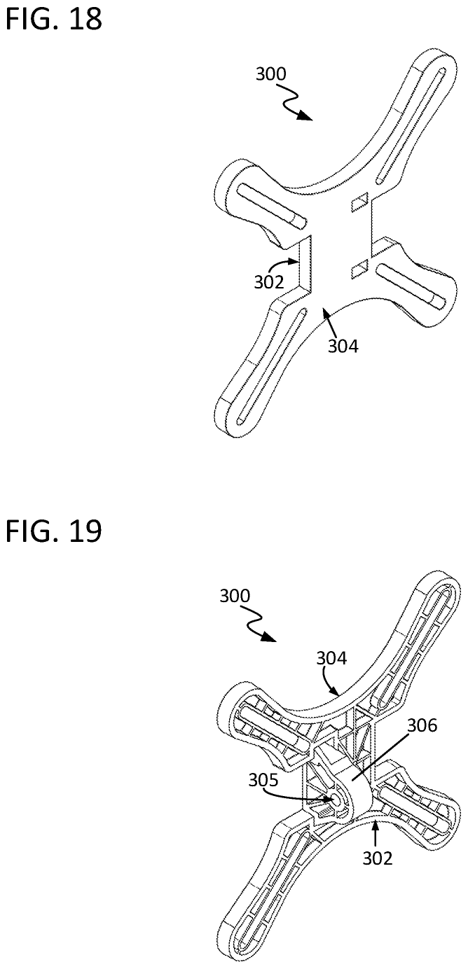

Assembly 1000 further may include a load mounting portion 300, as noted above. FIGS. 18-19 illustrate several views of a load mounting portion 300 configured in accordance with an embodiment of the present disclosure. As can be seen, load mounting portion 300 may be generally configured as a plate, the dimensions and geometry of which may be customized, as desired for a given target application or end-use. Load mounting portion 300 may be configured to have a given load mounted thereto in a temporary or permanent manner. To that end, forward side 304 (and/or other portion) of load mounting portion 300 may be configured to interface, directly or indirectly, with a given load, as desired. Some example suitable loads may include, for instance, an antenna (e.g., such as a radio frequency identity (RFID) antenna), surveillance equipment (e.g., such as a camera or video recorder), a scanner, a display (e.g., such as a monitor or television), or a sensor (e.g., such as an infrared (IR) sensor), among others. In some cases, load mounting portion 300 may interface with a given load in a manner that provides for a given degree of pivoting or flexing, though in other cases, a rigid or immovable interfacing with the load may be provided. In a more general sense, load mounting portion 300 may be configured to have a given load attached thereto in a manner that prevents (or otherwise reduces) the opportunity for unwanted movement of the load in relation to load mounting portion 300. Load mounting portion 300 may be configured to receive (or otherwise utilize) one or more securing means, such as bolts, screws, clamps, or ties, to name a few options. In some cases, load mounting portion 300 may be provided with a mounting hole pattern, such as, for example, a VESA mounting hole pattern (e.g., 50 mm, 75 mm, 100 mm, etc.).

A rearward side 302 of load mounting portion 300 may include an extension 306 having an aperture 305 formed therein. Extension 306 may be configured to have second arm 240 connected thereto. Extension 306 and its aperture 305 may be configured to provide for adjustment of the elevation angle/tilt of load mounting portion 300 (and, thus, any load hosted thereby). Extension 306 may be configured to interface with pivot point 245 of second arm 240.

A given element of assembly 1000 may be constructed from any of a wide range of suitable materials, including plastic(s), rubber(s), composite material(s), and/or metal(s) (including alloys), among others. In some cases, a given element of assembly 1000 may be constructed, for example, from a metal, such as stainless steel, copper, or brass, or an alloy of any thereof. In some cases, a given element of assembly 1000 may be constructed, for example, from a high-impact plastic or composite material. As will be appreciated in light of this disclosure, it may desirable, at least in some instances, to construct elements of assembly 1000 from materials amenable to the localized presence of magnetic field sources such as magnets 272, 274. Other suitable construction materials for assembly 1000 will depend on a given target application or end-use and will be apparent in light of this disclosure.

Numerous variations and configurations will be apparent in light of this disclosure. For instance, in accordance with some embodiments, assembly 1000 (additionally or alternatively) may include a hinge point and one or more torsion springs configured to realign/re-center load mounting portion 300 at a given nominal azimuth position and/or elevation/tilt angle, as desired.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.

What is claimed is:

1. A mounting assembly comprising:
a surface mounting portion configured to be mounted to a mounting surface;
a load mounting portion configured to have a load mounted thereto; and
a swing-arm with a centering mechanism connected with the surface mounting portion and the load mounting portion and configured to permit the load mounting portion to be deflected away from a nominal azimuth position and to return to that nominal azimuth position automatically.

2. The mounting assembly of claim 1, wherein the swing-arm with the centering mechanism comprises a gravity hinge portion comprising:
a lower gravity hinge part;
an upper gravity hinge part;
a hinge pin pivotally connecting the lower gravity hinge part and the upper gravity hinge part such that the upper gravity hinge part automatically realigns with the lower gravity hinge part from a deflected position to a nominal azimuth position under the action of gravity; and
at least one realignment assistance feature configured to assist with the automatic realignment of the upper gravity hinge part with the lower gravity hinge part.

3. The mounting assembly of claim 2, wherein the gravity hinge portion further comprises:
a first arm connected to the lower gravity hinge part and the surface mounting portion; and
a second arm connected to the upper gravity hinge part and the load mounting portion.

4. The mounting assembly of claim 3, wherein the load mounting portion is pivotally connected to the second arm.

5. The mounting assembly of claim 1, wherein the at least one realignment assistance feature comprises:
a spring situated with the hinge pin inserted therein, wherein the spring is configured to be compressed when the upper gravity hinge part is in the deflected position; and
a locking pin retaining the spring in position on the hinge pin.

6. The mounting assembly of claim 1, wherein the at least one realignment assistance feature comprises:
a first magnet hosted by the lower gravity hinge part; and
a second magnet hosted by the upper gravity hinge part;
wherein the first magnet and the second magnet are oriented such that there is magnetic attraction therebetween.

7. The mounting assembly of claim 6, wherein the first magnet is hosted in a recess provided in the lower gravity hinge part.

8. The mounting assembly of claim 6, wherein the second magnet is hosted in a recess provided in the upper gravity hinge part.

9. The mounting assembly of claim 2, wherein the at least one realignment assistance feature comprises:
a magnet hosted by one of either the lower gravity hinge part or the upper gravity hinge part; and
a magnetic plate hosted by the other of either the lower gravity hinge part or the upper gravity hinge part;
wherein the magnet and the magnetic plate are oriented such that there is magnetic attraction therebetween.

10. The mounting assembly of claim 9, wherein the magnet is hosted in a recess provided in either the lower gravity hinge part or the upper gravity hinge part.

11. The mounting assembly of claim 9, wherein the magnetic plate is hosted in a recess provided in either the lower gravity hinge part or the upper gravity hinge part.

12. The mounting assembly of claim 2, wherein the at least one realignment assistance feature comprises:
a first realignment assistance feature comprising:
a spring situated with the hinge pin inserted therein, wherein the spring is configured to be compressed when the upper gravity hinge part is in the deflected position; and
a locking pin retaining the spring in position on the hinge pin; and
a second realignment assistance feature comprising:
a first magnet hosted by the lower gravity hinge part; and
a second magnet hosted by the upper gravity hinge part;
wherein the first magnet and the second magnet are oriented such that opposite magnetic poles thereof are directed toward one another, permitting magnetic attraction therebetween.

13. The mounting assembly of claim 2, wherein the at least one realignment assistance feature comprises:
a first realignment assistance feature comprising:
a spring situated with the hinge pin inserted therein, wherein the spring is configured to be compressed when the upper gravity hinge part is in the deflected position; and
a locking pin retaining the spring in position on the hinge pin; and
a second realignment assistance feature comprising:
a magnet hosted by one of either the lower gravity hinge part or the upper gravity hinge part; and
a magnetic plate hosted by the other of either the lower gravity hinge part or the upper gravity hinge part;
wherein the magnet is oriented such that one of its magnetic poles is directed toward the magnetic plate, permitting magnetic attraction therebetween.

14. The mounting assembly of claim 1, wherein the swing-arm with the centering mechanism includes an azimuth adjustment feature.

15. The mounting assembly of claim 14, wherein the swing-arm with the centering mechanism further includes an elevation adjustment feature.

16. A system comprising:
the mounting assembly of claim 1; and
the load, wherein the load comprises at least one of an antenna, a radio frequency identification (RFID) antenna, surveillance equipment, a camera, a video recorder, a scanner, a display, a monitor, a television, a sensor, and an infrared (IR) sensor.

17. A mounting assembly comprising:
a surface mounting portion configured to be fixed to a mounting surface;
a first arm connected to the surface mounting portion;
a first gravity hinge part connected to the first arm;
a second gravity hinge part pivotally connected to the first gravity hinge part by a hinge pin such that the second gravity hinge part automatically realigns with the first gravity hinge part from a deflected position to a nominal azimuth position under the action of gravity;
a second arm connected to the second gravity hinge part;
a load mounting portion connected to the second arm and configured to host a load; and
at least one realignment assistance feature configured to assist with the automatic realignment of the second gravity hinge part with the first gravity hinge part.

18. The mounting assembly of claim 17, wherein the at least one realignment assistance feature comprises at least one magnet.

19. The mounting assembly of claim 18, wherein the at least one realignment assistance feature further comprises a magnetic plate disposed within a magnetic field of the at least one magnet.

20. The mounting assembly of claim 17, wherein the at least one realignment assistance feature comprises at least two magnets oriented with opposing magnetic poles directed toward one another.

21. The mounting assembly of claim 17, wherein the first arm is configured to be adjusted in its connection with the surface mounting portion so as to set the nominal azimuth position.

22. The mounting assembly of claim 17, wherein the second arm is configured to be adjusted in its connection with the load mounting portion so as to set an elevation angle of the load mounting portion.

23. A system comprising:
the mounting assembly of claim 17; and
the load, wherein the load comprises at least one of an antenna, a radio frequency identification (RFID) antenna, surveillance equipment, a camera, a video recorder, a scanner, a display, a monitor, a television, a sensor, and an infrared (IR) sensor.
